(19) United States
(12) Patent Application Publication
(10) Pub. No.: US 2022/0160166 A1
(43) Pub. Date: May 26, 2022

(54) Gasifier Stove

(71) Applicant: Wei Zhang, Delta (CA)

(72) Inventor: Wei Zhang, Delta (CA)

(21) Appl. No.: 17/531,770

(22) Filed: Nov. 21, 2021

Related U.S. Application Data
(60) Provisional application No. 63/116,778, filed on Nov. 20, 2020.

(51) Int. Cl. A47J 33/00; F24B 1/20

(52) U.S. Cl. CPC A47J 33/00; F24B 1/207; F24B 1/205

(57) ABSTRACT

A system and method of tracking and classifying an athlete's stick techniques used during a sporting event are disclosed, which includes measuring detailed motions and position of at least one stick object being used in sports, producing relevant stick technique patterns and classifying those patterns in a relevant manner. Classified stick pattern data is used to improve the accuracy and clarity of sporting event metrics, the ability to quantify athlete's skill and the ability to develop athletes based on their game situation techniques. The method used allows for accurate, near real-time discovery of stick patterns during live sporting events without altering or impacting the game or an athlete's ability to perform.

### RELATED APPLICATIONS

This application claims priority to U.S. Application No. 63/116778, filed on Nov. 20, 2020, the disclosure of which is incorporated herein by reference in its entirety.

### FIELD OF THE INVENTION

The present invention related to biomass-burning stoves, particularly camping and hunting stoves

### BACKGROUND

In outdoor and hunting activities, wood-burning stoves are commonly used to warm a tent or cabin. The stove may be of the open fire, dosed box or gasifier type. The latter is more efficient, employing secondary burning to burn wood gas that is emitted from the primary burn stage. The smaller of these are portable but do not produce much heat for warming a space. Large wood burning stoves may be powerful but very heavy. In certain applications it is desirable to have a portable and yet powerful stove for easily transporting to and heating large recreational living spaces.

### BRIEF DESCRIPTION OF THE DRAWINGS

Present inventions of the preferred embodiment may be described with reference to the following figures in which like references correspond to like parts, in which:

FIG. 1 is a perspective view of a gasifier stove;

FIG. 2 is a perspective view of a gasifier stove in a folded position;

FIG. 3 is an exploded diagram of a gasifier stove with first air flow;

FIG. 4 is an exploded diagram of a gasifier stove with second air flow;

FIG. 5 is an exploded diagram of a gasifier stove with exit air flow;

FIG. 6 is a sectional diagram through the stove showing the two burning areas;

FIG. 7 is an exploded view of a stove door with indexing vent;

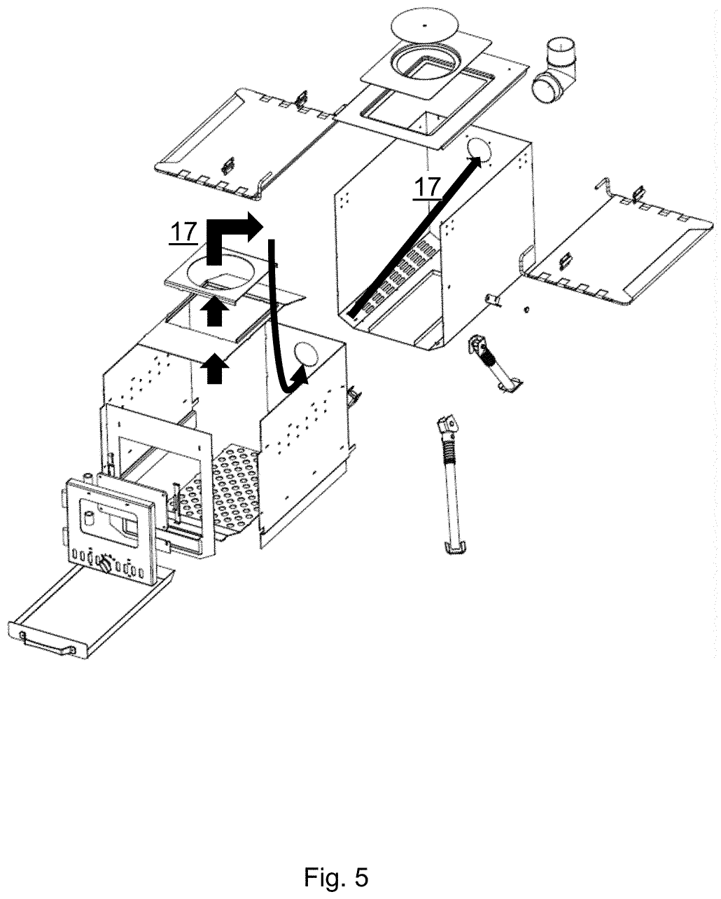

FIG. 5 is a side view of a stove;

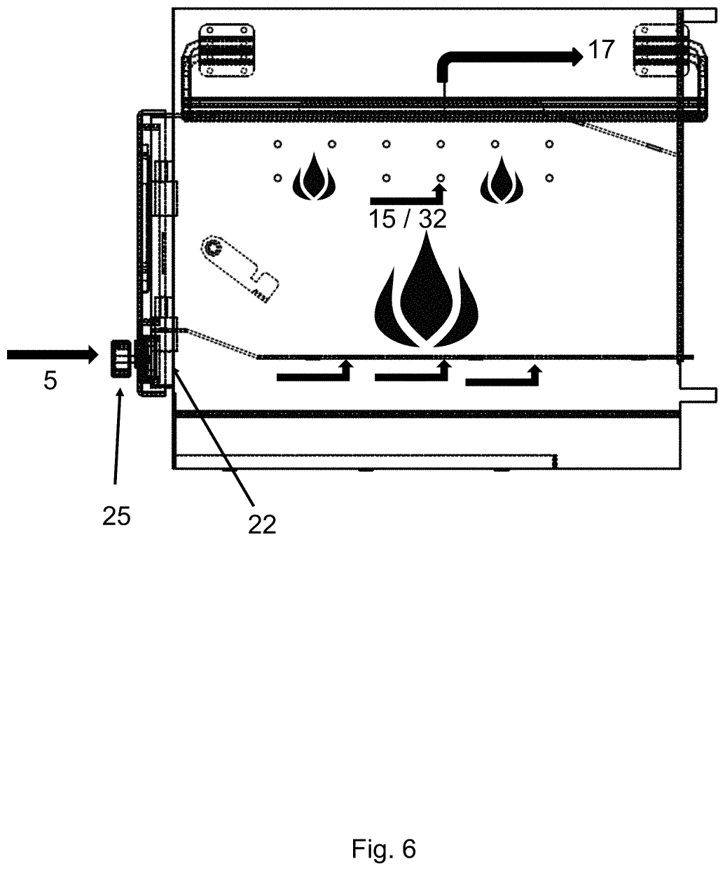

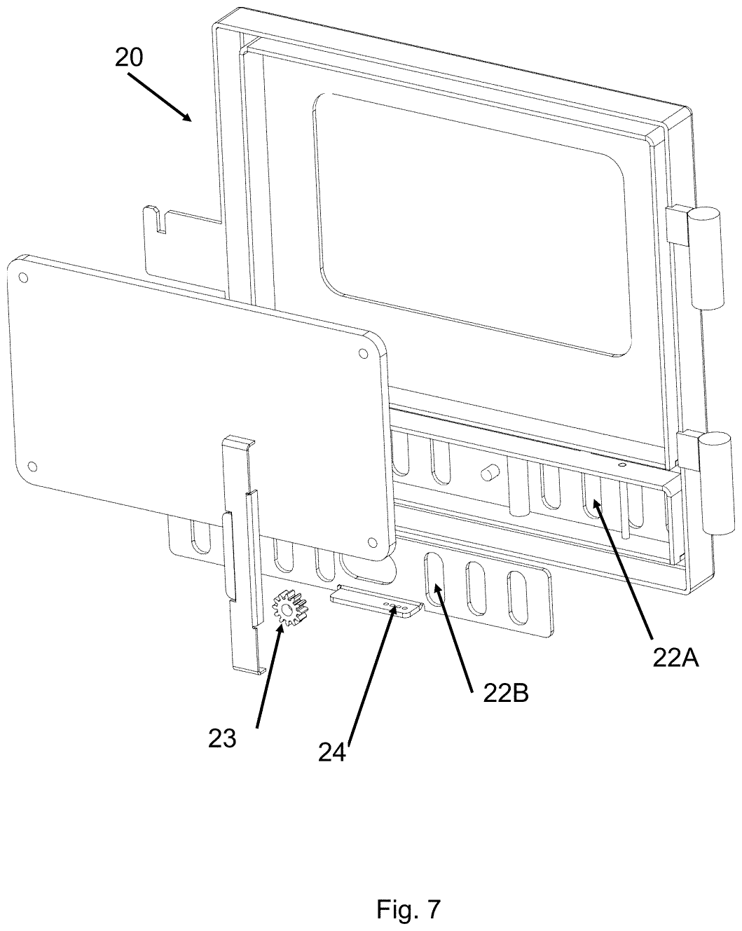

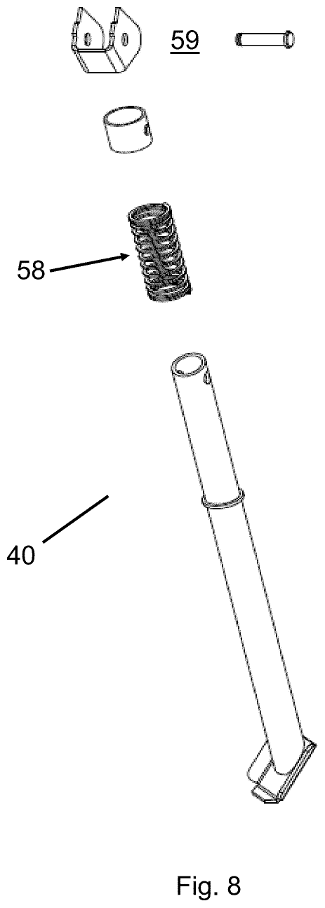

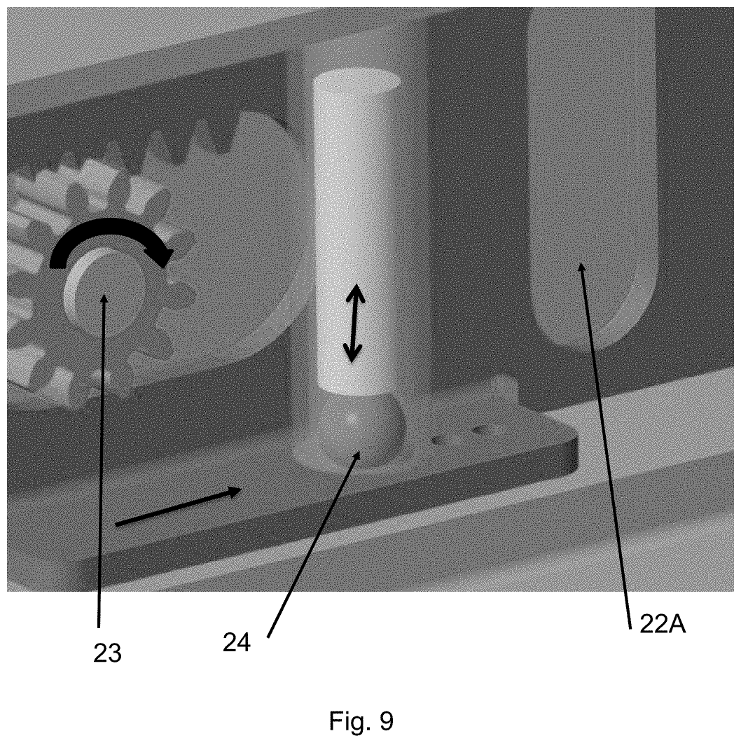

FIG. 6 is a view of a side tray for drawing in a collapse position;

FIG. 8 is an exploded diagram of a collapsible stove leg;

FIG. 9 is a perspective view of an indexing vent mechanism; and

FIG. 10 is a view of a chimney with a latch.

### SUMMARY OF THE INVENTION

In general, the present invention provides a gasifier stove, particularly those used to warm up a cabin or tent.

According to one aspect there is a biomass-burning stove comprising: an outer housing; a biomass-burning chamber located within the outer housing and spaced-apart from a wall of the outer housing, the chamber having a biomass-receiving base at its bottom and baffle plate at its top; a chimney connectable to the outer housing at a location above the baffle plate; first air vents in the housing for directing air to the base of the burning chamber, which first vents are variable in area; and second air vents in the outer housing for supplying air to third air vents at the top of the burning chamber.

### DESCRIPTION OF THE PREFERRED EMBODIMENTS

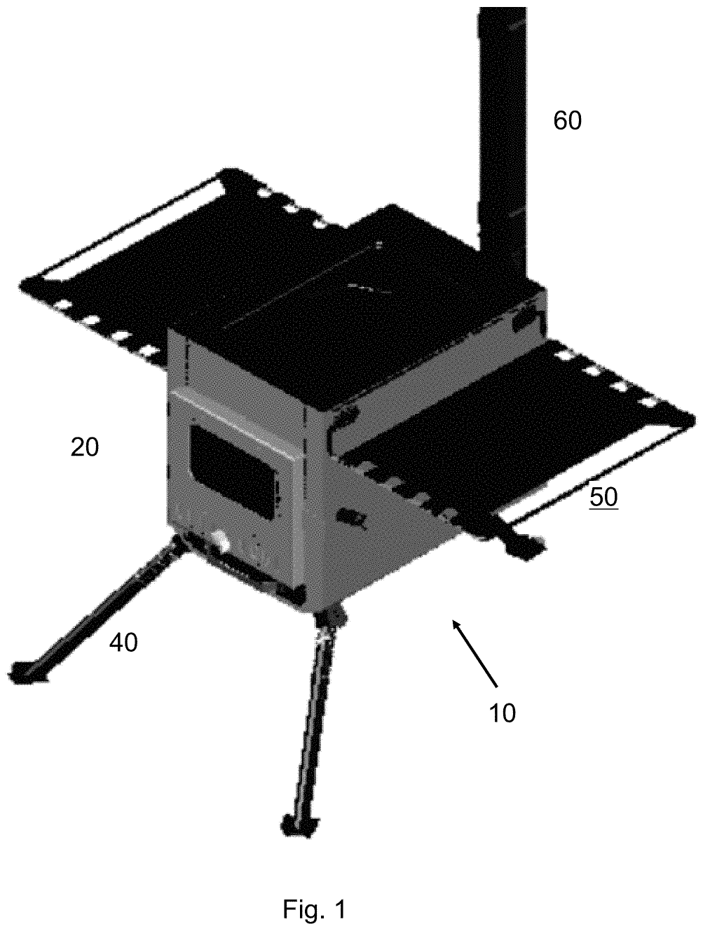

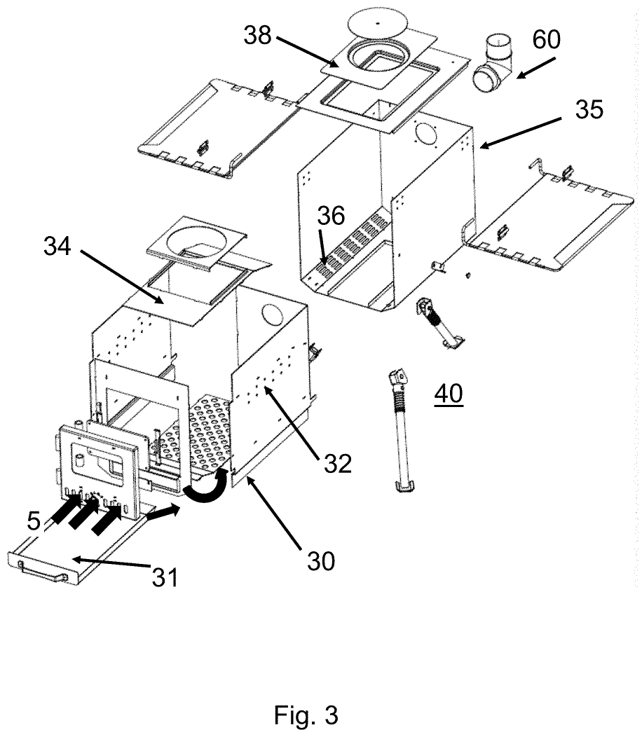

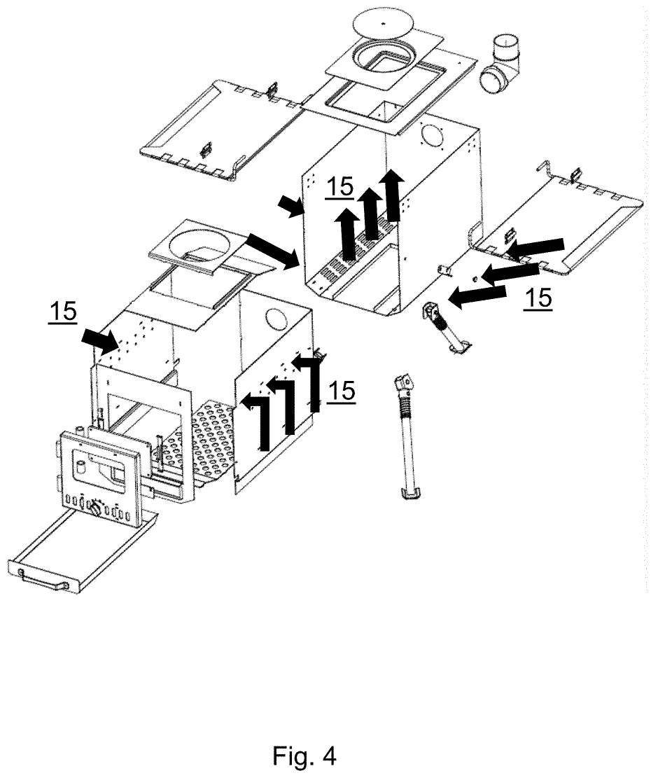

The invention will now be described in detail with reference to the accompanying drawings. Provided are apparatus and methods for using a gasifier stove. FIG. 1 shows a preferred embodiment of a stove 10 having an outer housing 35, chimney 60, front door 20, legs, cooktop surface and vents. As shown in the exploded diagram of FIG. 3, there is an inner housing 30 within and spaced apart from the walls of the outer housing 35. The inner housing defines a burning chamber for the biomass and pyrolysis-based wood gas, and ashtray 31 below.

One preferred form of the stove is that of a double-walled housing, created by an inner housing 30 with burning chamber an outer housing 35 surrounding and spaced apart from the inner chamber, with venting therebetween to control primary 5 and secondary air 15 inlet flow for primary and secondary burning. As shown in FIG. 6, the bottom of the inner housing defines a biomass burning chamber for receiving biomass, such as wood, twigs, charcoal, and other dry biomass. This is the primary burning chamber which is set alight and burns biomass to releases wood gas through pyrolysis. Vents 22 in the outer housing, preferably in the door 20 of the outer housing, direct first air flow 5 to the primary burning chamber. As the biomass burns, wood gas is released and rise, where it mixes with fresh air in the top of the burning chamber, which is supplied with secondary air flow 15 through vents 32 On the inner housing) and 36 (in the outer housing) in the space between the inner and outer housing.

A baffle 34 at the top of the burning chamber, controls the exit of wood gas and air to optimize the mixing and burning in the secondary stage. Preferably the area of vents 32 and 36 are similar to each other. Preferably each of these vent areas are between 50% and 120% of the area of variable vent 22 in the fully open setting.

### Ash Tray

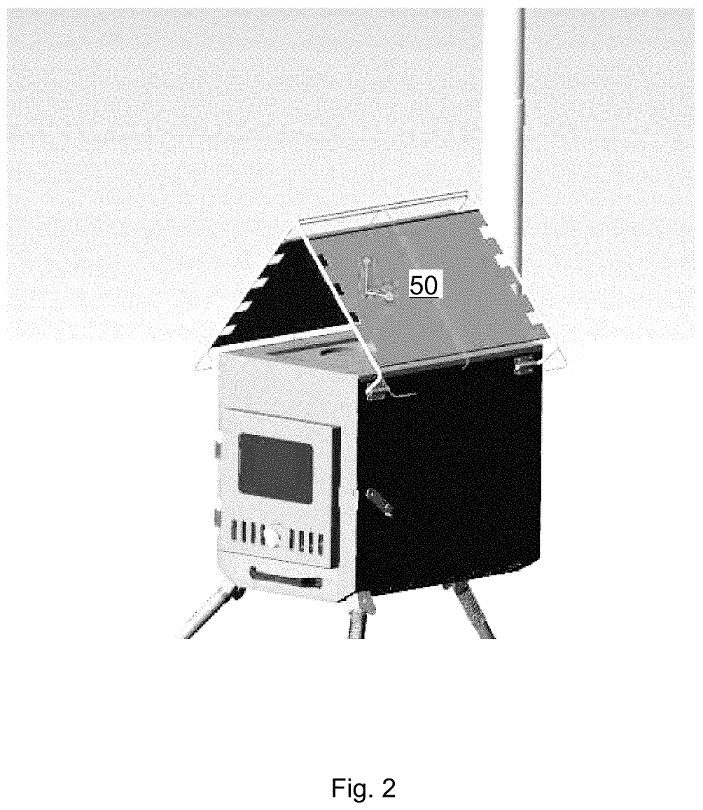

Removable ashtray 31 is located below the burning chamber and receives ash from the burned biomass, which drops through holes in the base of that chamber. As shown in FIG. 2, the ashtray may be accessed from the front of the housing.

First vents 22 in the outer housing control air flow to the primary burning. The area of these vents is variable to optimize the present combustion stage, i.e. different air flow rates are required for starting combustion versus medium and high burn rates. In preferred embodiments the venting area is controlled by knob 25 which provides finer control of the vent opening then is possible with a sliding vent. The knob controls the vent area via gear 23 that slides a first plate with holes 22B over vents 22A in the housing. Thus the knob is coupled to the vent to translate user rotation into linear vent control. In a preferred embodiment there are a plurality of vent holes 22B, whereby additional discrete vents 22A are opened with every indexing of the control knob 25.

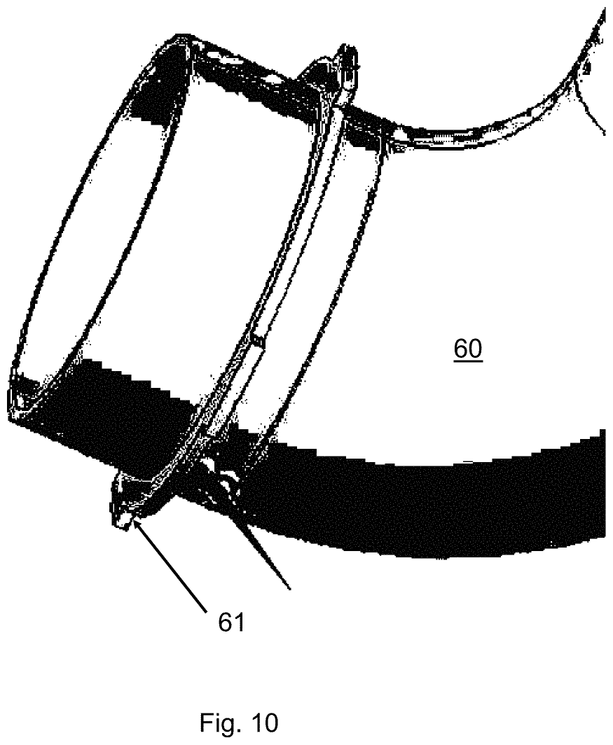

Advantageously, as shown in FIGS. 7 and 9, the vent controller further comprises an indexer 24 to set the vent area to finite, predefined values suitable for starting, medium burn (e.g. warming) and high burn applications (e.g. cooking). Indexing may be achieved by biased detent(s) cooperating with recess(es) to provide discrete airflow settings, preferably providing a tactile or audible feedback for each setting. In the starting position, the airflow is lowest to allow the primary combustion to begin. Typically, after seven to twelve minutes, the primary burning starts to release with gas through pyrolysis. At this point, the vent 22 can be set to the medium airflow for medium burn rate.

The vents 32 and 36 for the secondary burning may also be of variable type to control the rate of secondary burning relative to primary burning. The skilled person will appreciate that the size shape in orientation of the events may be varied and remain within the scope of the invention.

As shown in FIGS. 5 and 6, the exhaust gases 17 flows up through the hole in baffle 34 then out through the rear holes in the inner and outer housing to the chimney 60. The general flow of inlet air from the front door towards the rear biases the exhaust direction rearwards.

### Drying Racks

As shown in FIGS. 1 and 2, the stove may further comprise foldable drying racks 50, movable between a collapsed/portable position and an expanded/drying position. Holes or hooks on the drying racks maybe use to attach items to be dried. These items then hang down proximate the sides of the outer housing, which is hot and promotes drying.

### Legs

Collapsible legs 40 are mounted to the outer housing to lift the stove off the ground in an extended position, while still being small enough to be portable in the stowing position. Springs 58 and locking mechanism 59 bias and hold the legs to lock into the extended position for use, while relieving the force on the spring enables the leg to be released from the lock to collapse against the base of the housing for stowing. Typically there will be three or four legs for a stove

### Chimney

The hot burned gases are removed from the stove via the chimney 60 which is mounted at the top and back of the housing. For improved portability, the chimney may be comprised of plural segments that are connectable or nestable to each other. As shown in FIG. 10, the inlet to the chimney may comprise a locking means 61 for releasably connecting to the housing. The locking means may comprise flange segments that cooperate with the housing by insertion and twisting to hold the chimney in place.

The exit to the chimney is directed to an exit of the living space or through a pipe jack in a tent. The chimney may include a damper to adjust exit flow during burning or block flow when not in use.

The top of the outer housing may be used as a cooking service, either by simply placing cookware on top of it or by removing plates on the top of the outer housing to expose the flame.

Without being limited to any modality or particular theory of operation, the stove is intended to work as follows. Biomasses is loaded into the base of the burning chamber with the largest biomass on bottom and lighter kindling on top. The kindling is then ignited. At this point the vent is already set to its lowest level, so as to start the fire without putting it out. After several minutes, the heat from the lit kindling will ignite the lower and heavier biomass, such as logs. Eventually wood gas will be released from the larger biomass through pyrolysis (degeneration of the wood components in the absence of oxygen). This wood gas will collect at the top of the burning chamber, but is restricted by the above baffle plate 34. As the fresh air 15 enters through the air vents 32 at the top of the burning chamber, it mixes with and burns the wood gas. The design of the top of the burning chamber, in particular the baffle and air vents, ensures that there is proper mixing, while reducing dispersion of the wood gas. This optimizes this secondary burning at the top of the burning chamber.

The twice burned fuel then leaves thru a hole in the baffle plate, to intensely heat the top of the cooking surface 38 and then escapes through the chimney 60, located at the top and rear of the outer housing.

### Assembly

As shown in FIG. 3 the inner and outer housing may be constructed substantially as rectangular metal boxes with vents therethrough and nested within each other. Alternatively, the outer housing is made and internal plates are welded therewithin to form the chambers. Chambers within the inner housing may be created using horizontal plates welded to the vertical sidewalls with additional holes drilled therethrough as vents, such that these plates act as baffles. The size, location, and number of holes are chosen to optimize flow and mixing of gases (air and wood gas). The inner and outer housings may be casted or constructed from sheet metal and welded into a rectangular box, with vent holes drilled or punched therethrough.

An ashtray compartment is located at the bottom of the inner housing, below the base that holds the burning biomass, It is inserted through a suitably shaped cut-out in the outer housing. A door 20 is mounted on hinges to the front of the outer housing with a latch opposite the hinged side. To the outer housing are connected collapsible legs, cooking plates, drying trays, and a chimney.

Terms, such as “top, bottom, above below, front, rear, and side” are intended to provide clarity of relative locations and parts of the stove when in normal use.

1. A biomass-burning stove comprising:
an outer housing;
a biomass-burning chamber located within the outer housing and spaced-apart from a wall of the outer housing, the chamber having a biomass-receiving base at its bottom and baffle plate at its top;
a chimney connectable to the outer housing at a location above the baffle plate;
first air vents in the housing for directing air to the base of the burning chamber, which first vents are variable in area; and
second air vents in the outer housing for supplying air to third air vents at the top of the burning chamber.

2. The stove of claim 1, further comprising a door comprised in the outer housing for accessing the burning chamber

3. The stove of claim 2, wherein the door has said first air vents and control means to vary the area of the first air vents.

4. The stove of claim 1, further comprising a plurality of collapsible legs connected to the outer housing and movable between an extended position and a stowed position.

5. The stove of claim 1, further comprising a removable ash tray located below the biomass-receiving base.

6. The stove of claim 1, further comprising a first vent control, for indexing between plural airflow settings of the first air vents. The stove of claim 1, further comprising a removable plate in a top of the outer housing.

8. The stove of claim 1, further comprising drying racks connected to the outer housing and moveable between an extended drying position and a stowed position

9. A method of using a gasifier stove comprising the unpacking steps of:
connecting a chimney to a housing of the stove;
extending plural legs attached to the stove to an extended position away from a base of the stove;
loading a burning chamber with biomass;
lighting a top of the biomass; and
setting a first vent, having plural indexed airflow settings, to a lowest airflow setting, which first vent provides air to the burning chamber.

10. The method of claim 9, further comprising, setting the first vent to a higher airflow setting during a secondary burning of wood gas in an upper part of the burning chamber.

11. The method of claim 9, wherein the first vent is coupled to a control knob, rotatable to change the plural indexed airflow settings.

12. The method of claim 9, further comprising assembling the chimney from plural tube segments.

13. The method of claim 9, further comprising varying a second vent area to control airflow to the secondary burning.
